(19) United States
(12) Patent Application Publication
(10) Pub. No.: US 2015/0375261 A1
(43) Pub. Date: Dec. 31, 2015

(54) METHOD OF FORMING A PIGMENT LAYER AND A FOAM LAYER ON A SUBSTRATE AND A CONTAINER TREATED BY THE SAME

(71) Applicant: RICH CUP BIO-CHEMICAL TECHNOLOGY CO., LTD., Taichung (TW)

(72) Inventors: Sheng-Su Chang, Taichung (TW); Ching-Wen Chang, Taichung (TW)

(21) Appl. No.: 14/825,753

(22) Filed: Aug. 13, 2015

Related U.S. Application Data
(63) Continuation-in-part of application No. 13/759,376, filed on Feb. 5, 2013.
Application No. 13/759,376 is a continuation-in-part of application No. 12/837,727, filed on Jul. 16, 2010, now abandoned.

(51) Int. Cl. B05D 1/36; B05D 3/00

(52) U.S. Cl. CPC B05D 1/36; B05D 3/007

(57) ABSTRACT

The method of forming a pigment layer and a foam layer on a substrate includes steps of material preparation, material coating, pigment coating and foaming. A coating material layer is coated on the substrate, and then a pigment layer is coated on the substrate before the coating material layer is foamed. Thus the pigment can be coated on the substrate more quickly, easily and more accurately.

### FIELD OF THE INVENTION

The present invention is a CIP of application Ser. No. 13/759,376, filed Feb. 5, 2013, which is a CIP of application Ser. No. 12/837,727, filed Jul. 16, 2010, the entire contents of which are hereby incorporated by reference.

### BACKGROUND OF THE INVENTION

### Description of the Prior Art

There are some containers printed with patterns to show the contents and/or marketing information. There are also some containers coated with foam layer to mitigate the heat conductance, as disclosed in Taiwan patent applications whose app. no. are 94143974 and 96102426. Both the Taiwan patent applications disclose that pigment can be added into the coating material, thus the foam layer becomes colorful when the coating material is foamed. They also disclose that the foam layer can be printed to have patterns. However, printing on a non-smooth surface makes the patterns vague.

U.S. Pat. No. 5,952,068 also discloses a container with a foam layer(s), and '068 also taught that the coating material can be mixed with a pigment. As shown in FIG. 5 of '068, a label area is formed on the container, yet '068 remains silence how to make the patterns accurately print on a non-smooth surface, especially one with expandable layer.

U.S. Pat. No. 4,172,169 discloses that the decorative coating of solid plastics material is disposed on the surface layer of foamed plastics material, and the decorative coating is further covered by the non-foamed layer. No part of the decorative coating is exposed to outside. It is clear that the decorative coating is entirely flat and not thinned at the lateral side of two foamed layers, and thus it cannot provide more stereoscope continuous pigment layer on the substrate on which the decorative coating is disposed. Besides, the printed patterns disposed on the foamable layer are vague, inaccurate and unprecise, and the decorative coating cannot provide stereoscope effect at all.

Please refer to FIG. 6 and FIG. 7. As taught in the disclosure hereinabove, the pigment is printed on the foam layer 3 and on the outer surface of the container. However, there is a height drop between the foam layer 3 and the outer surface, which makes it hard to print, especially on the side surface 5 of the foam layer 3. Most of the time, such side surface 5 cannot be successfully fully printed with pigments. Further refer to FIG. 8. If one were to print patterns on the gap between the foam layers 3, it would be another hard task because the foam layers 3 would block the printing nozzle. Thus the patterns could not be printed accurately.

The present invention is, therefore, arisen to obviate or at least mitigate the above mentioned disadvantages.

### SUMMARY OF THE INVENTION

The main object of the present invention is to provide a method to accurately form a foam layer and a pigment layer on a substrate.

To achieve the above and other objects, the method of the present invention includes the following steps:

preparing a coating material by mixing and blending a binder and a thermo-expandable powder consisting of a plurality of thermo-expandable microcapsules, each thermo-expandable microcapsule consisting of a thermoplastic polymer shell and a low-boiling-point solvent wrapped by the thermoplastic polymer shell, the coating material being light transmissive, a low-boiling point of the low-boiling-point solvent being lower than a foaming point of the thermo-expandable microcapsules, the foaming point being within 80-200 degrees Celsius;

coating the coating material on a part of an outer surface of the substrate to form a coated layer, at least one non-coated portion being formed on the substrate, the non-coated portion being defined by the coated layer;
coating a pigment on at least a part of the non-coated portion to form a pigment layer; and
heating the coated substrate till the coated layer foams so that the coated layer becomes a foam layer, the non-coated portion being thus defined by the foam layer instead;
wherein the pigment is coated on the outer surface of the substrate before the coating material is coated on the outer surface of the substrate, a part of the pigment layer covers on at least a partial area of the non-coated portion and another part of the pigment layer is covered by the coated layer, the part of the pigment layer which covers on entire area of the non-coated portion and the another part of the pigment layer which is covered by the coated layer are continuous.

To achieve the above and other objects, another method of the present invention includes the following steps:

preparing a coating material by mixing and blending a binder and a thermo-expandable powder consisting of a plurality of thermo-expandable microcapsules, each thermo-expandable microcapsule consisting of a thermoplastic polymer shell and a low-boiling-point solvent wrapped by the thermoplastic polymer shell, the coating material being light transmissive, a low-boiling point of the low-boiling-point solvent being lower than a foaming point of the thermo-expandable microcapsules, the foaming point being within 80-200 degrees Celsius;

coating a pigment on at least a part of substrate to form a pigment layer;
coating the coating material on a part of an outer surface of the pigment-coated substrate to form a coated layer, at least one non-coated portion being formed on the substrate, the non-coated portion being defined by the coated layer, at least a part of the pigment layer being located in the non-coated portion and continuously extending to terminate between the coated layer and the outer surface of the substrate so that the at least a part of the pigment layer is partially overlapped by the coated layer; and
heating the coated substrate till the coated layer foams so that the coated layer becomes a foam layer, the non-coated portion being thus defined by the foam layer instead.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a flow chart of a method of the present invention;

FIG. 1A is a flow chart of another method of the present invention;

FIG. 1B is a profile showing a substrate coated with a pigment layer and then a coated layer of the present invention;

FIG. 1C is a profile showing a substrate coated with a pigment layer and then a coated layer, in which the coated layer is formed to become a foam layer of the present invention.

FIG. 2A is a profile showing a substrate coated with a coated layer and then a pigment layer of the present invention;

FIG. 2B is a profile showing a substrate coated with a coated layer and then a pigment layer of the present invention, in which the coated layer is formed to become a foam layer;

FIG. 3A is a profile showing another substrate coated with a coated layer and then a pigment layer of the present invention;

FIG. 3B is a profile showing another substrate coated with a coated layer and then a pigment layer of the present invention, in which the coated layer is formed to become a foam layer;

FIG. 4A is a profile showing yet another substrate coated with a coated layer and then a pigment layer of the present invention;

FIG. 4B is a profile showing yet another substrate coated with a coated layer and then a pigment layer of the present invention, in which the coated layer is formed to become a foam layer;

FIG. 5 is a perspective drawing showing a container of the present invention;

FIG. 6 is a profile showing a substrate coated with a foam layer and a pigment layer of the prior art;

FIG. 7 is a profile showing another substrate coated with a foam layer and a pigment layer of the prior art;

FIG. 8 is a profile showing yet another substrate coated with a foam layer and a pigment layer of the prior art.

### DETAILED DESCRIPTION OF THE PREFERRED EMBODIMENTS

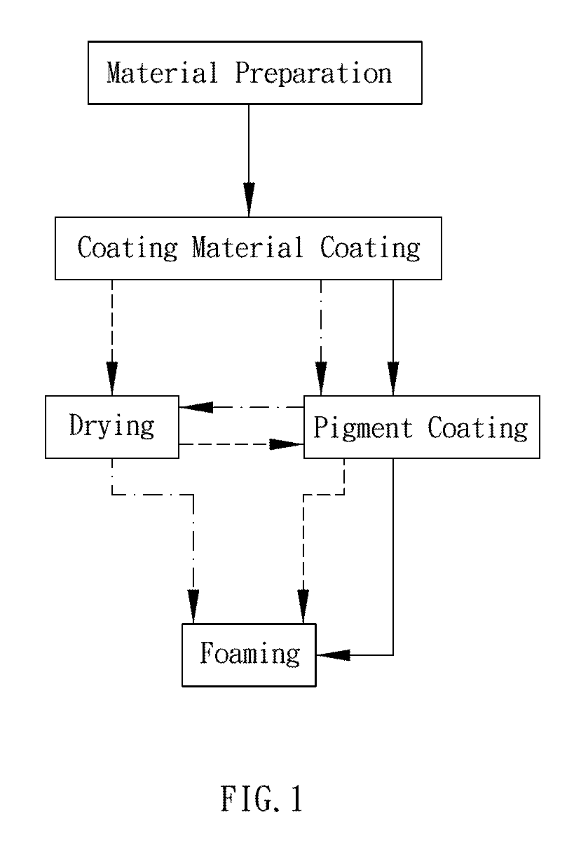

Please refer to FIG. 1. A method of forming a pigment layer and a foam layer on a substrate includes the following steps:

Material Preparation: preparing a coating material by mixing and blending a binder and a thermo-expandable powder consisting of a plurality of thermo-expandable microcapsules, each of which consists of a thermoplastic polymer shell and a low-boiling-point solvent wrapped by the thermoplastic polymer shell. In this embodiment, the coating material being light transmissive, a low-boiling point of the low-boiling-point solvent is lower than a foaming point of the thermo-expandable microcapsules, wherein the foaming point being within 80-200 degrees Celsius. Generally, the foaming temperature is preferably controlled within 80-200 degrees Celsius. The use of material of the low-boiling-point solvent may be optional according to the foaming temperature.

The binder is preferably selected from a group consisting of polyvinyl acetate resin, ethylene vinyl acetate resin, polyurethane resin and a mixture thereof, and the binder can be either water soluble resin or oleoresin. Preferably, the binder is oleoresin preferably including an oil-based polyurethane resin (polyethylene terephthalate (PET) or polypropylene (PP)), and a weight of the polyurethane resin accounts for 5% to 20% of a total weight of the polymer material (coating material).

Coating Material Coating: coating the coating material on a part of an outer surface of the substrate to form a coated layer, and at least one non-coated portion being formed on the substrate, in which the non-coated portion is defined by the coated layer. The substrate can be paper, plastic, Styrofoam or the like, and the substrate is adapted to be manufactured into a container such as a cup, a bowl, a disc or the like. For example, the substrate can be a paper reel and can be subsequently cut and assembled into a paper cup. Further, the coating material can be coated on the substrate in the manner of rolling, spraying, dipping, printing, air knife, extruding, scraper applying or the like.

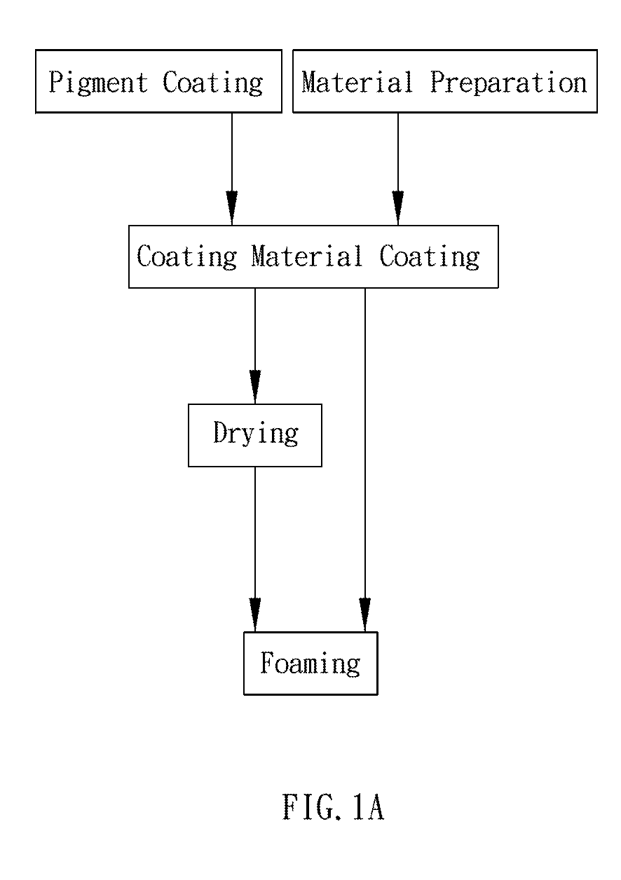

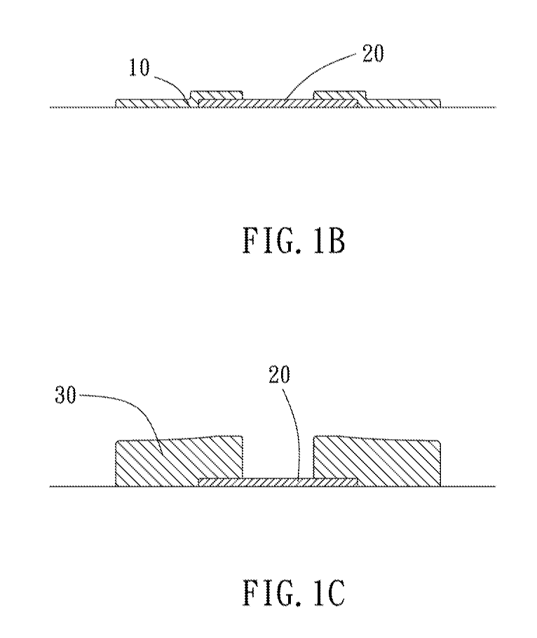

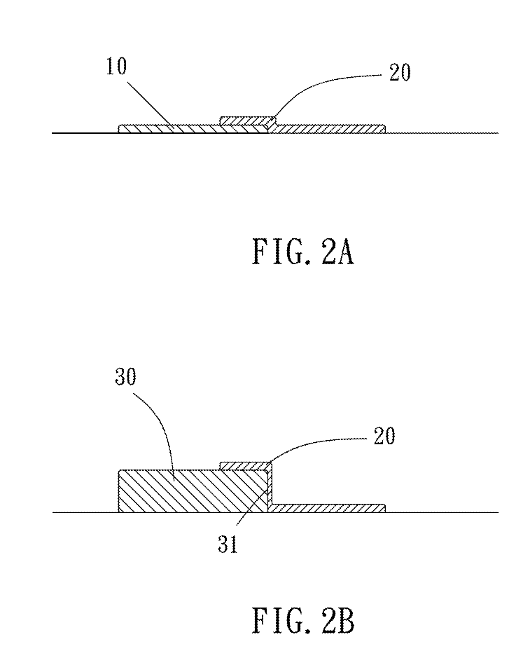

Pigment Coating: coating a pigment on at least a part of the non-coated portion to form a pigment layer, and preferably the coated layer is also coated to have a pigment layer itself. The pigment layer and the foam layer is disposed on a first side face of the substrate, and a second side face of the substrate which is opposite to the first side face is entirely uncovered. For example, FIG. 2A and FIG. 3A show a continuous pigment layer 20 is coated on the coated layer(s) 10 as well as the non-coated portion, while FIG. 4A shows the pigment layer 20 are coated on the narrow non-coated portion sandwiched between two adjacent coated layers 10. Due to the unobvious height drop between the coated layer 10 and the substrate, the pigment layer can thus be easily and precisely coated on the non-coated portion and the coated layer.

Foaming: heating the coated substrate till the coated layer foams so that the coated layer becomes a foam layer. The thickness of the foam layer is at least twice that of the coated layer. Please refer to FIG. 2B and FIG. 3B. As the coated layer(s) expands and becomes the foam layer 30, the pigment layer 20 on the coated layer(s) is thus propped up, yet the side surface(s) 31 of the foam layer 30 is still covered by the pigment layer. Thus the pattern of the pigment layer can still be continuous. Further refer to FIG. 4B. As the coated layers expand, the pigment layer 20 can still locate at the narrow non-coated portion.

Since the substrate is made from non-foamable material having a very smooth outer surface and at least one non-coated portion being formed on the substrate, the pigment layer can be more precisely, easily and accurately coated on the non-coated portion of the substrate, and the pattern at the non-coated portion and coated portion is more highlighted and looks more stereo. Additionally, the pigment layer is coated on the coated layer after the coated layer is dried to become a non-sticky coated layer, so that the pigment layer and the coated layer is not mixed up and the pigment layer cannot be blurred by the coated layer, and thus the pigment layer is purely clear. Moreover, the pigment layer is continuously on the foam layer and the non-coated portion and is entirely exposed to outside a continuous stereoscope pigment layer is formed easily. Additionally, the pigment layer is continuously printed on the unfoamed coating material and the non-coated portion. When the coating material is heated and foamed, the pigment layer on the coating material is lifted to enhance stereoscope effect. In other words, please refer to the following figure, when being foamed, the coating material (two layers at two sides) is inflated, and the thickness of the coating material is increased. Thereby, the pigment layer on the coating material is lifted by the inflated coating material, thus showing a continuous stereoscope pattern.

In an alternative embodiment, the coated layer(s) 10 on the outer surface of the substrate and the pigment layer 20 is instantaneously heated with a heating device (not shown), preferably, in a manner of directly touching the coated layer(s) 10 with the heating device and of disposing the heating device closely to an inner surface of the substrate so as to instantly heat the inner surface without touching it, so that the coated layer(s) 10 foams uniformly and the foaming time of the foam material is shortened.

In the present invention, the coating material may contain oil-based polyethylene terephthalate (PET) or polypropylene (PP) which can resist high temperature (200° C. or higher). Thus, the coated layer 10 can be prevented from damaging by heat under a foaming temperature. Moreover, the heating device heats the substrate by two ways, by two sides of the substrate, in the same time. More specifically, the inner surface is heated by the heating device disposed closely to the inner surface without directly touching it, and the outer surface is heated by the heating device by directly contacting. Due to the heating by double sides and heating the coated layer 10 instantaneously and simultaneously and the coating material may contain oil-based polyethylene terephthalate which can be treated under the relatively higher temperature instantly to complete foaming procedure, the coated layer 10 can be foamed uniformly and quickly (20-40 seconds or longer in the prior art; less than 20 seconds in the present invention), and further can be prevented from damaged or decomposed by a relatively high temperature (about 200° C. or higher). As such, the foaming time is thus much shortened so that cost is reduced, the yield rate is promoted, and it is non-toxic.

It is noted that an additional film containing an oil-based polyurethane resin and having a weight of the polyurethane resin accounts for 5% to 20% of a total weight may be coated (for example, by heating) on the inner surface of the substrate. Similarly, due to the heating by double sides and heating the coated layer 10 instantaneously and simultaneously and the coating material may contain oil-based polyethylene terephthalate which can be treated under the relatively higher temperature instantly to complete foaming procedure, the coated layer can be foamed uniformly and quickly, and further can be prevented from damaged or decomposed by a relatively high temperature (about 200° C. or higher). As such, the foaming time is thus much shortened so that cost is reduced, the yield rate is promoted, and it is non-toxic. A drying step can be further included in the present method, in which the drying step is to dry the coated layer at a temperature lower than a foaming point, where the foaming starts, of the thermo-expandable microcapsules so that the coated layer can adhere to the substrate and becomes a non-sticky coated layer. As such, the coated substrate can be stored for later use. More specifically, the drying step is either between the pigment coating step and the foaming step or between the coating material coating step and the pigment coating step.

Because the pigment layer is coated on the substrate before the coated layer expands, the pigment layer can be more precisely coated on the substrate, and the side surface of the foam layer can still be covered by the pigment layer.

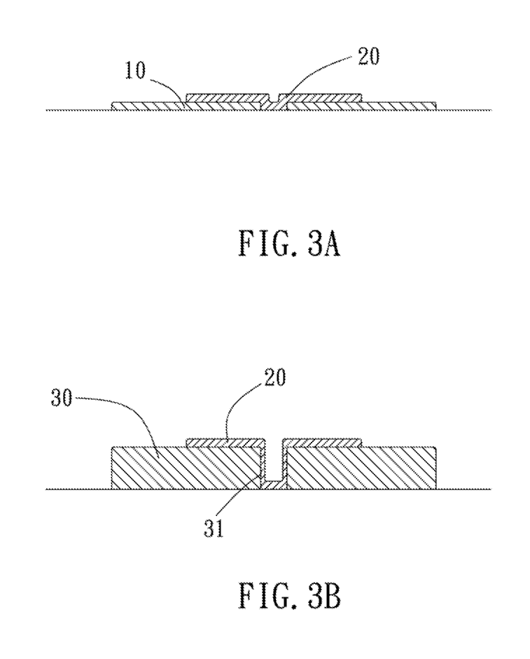

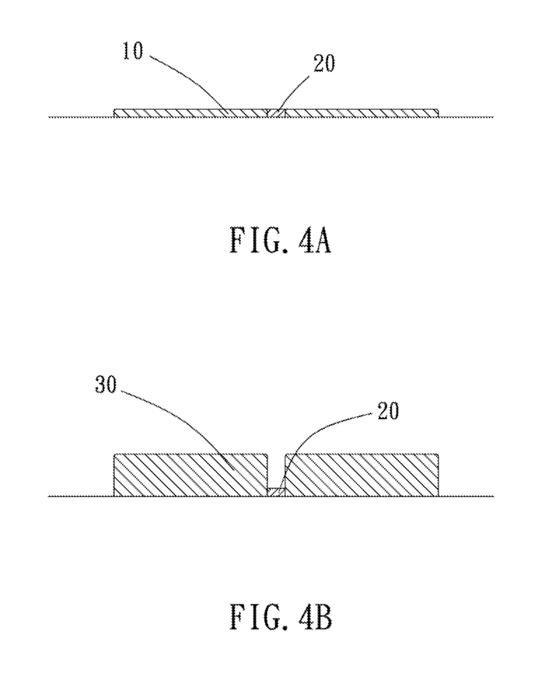

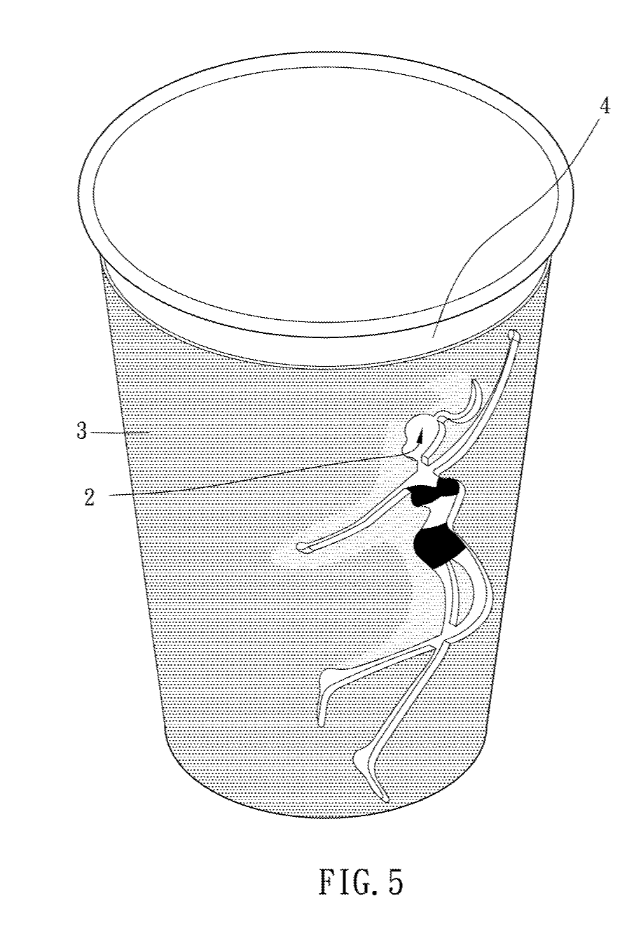

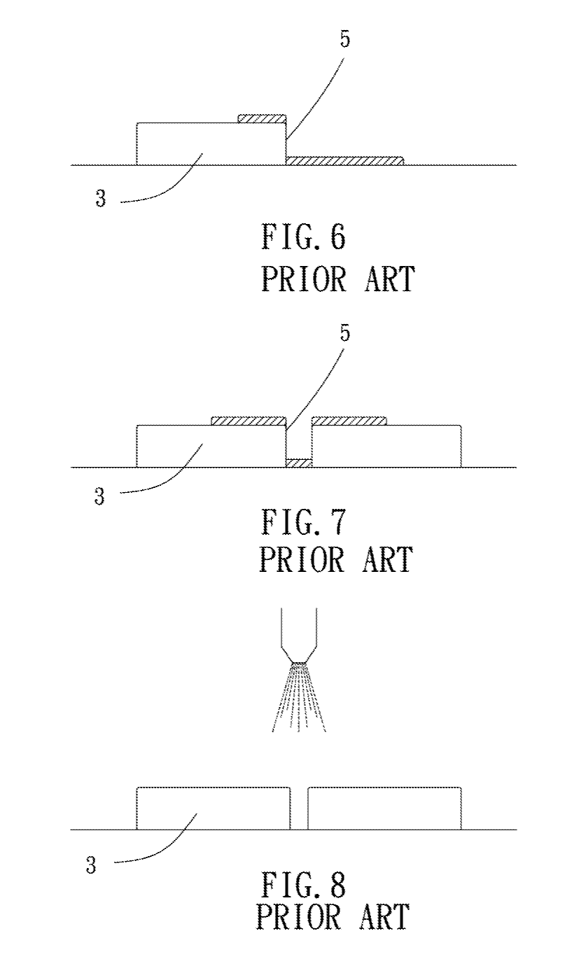

As shown in FIG. 5, the cup has a body 4 and a bottom disposed on a lower end of the body 4. The body 4 is made by annularly bending fixing the substrate, thus a foam layer 20 with a non-coated portion 2 is formed on the outer surface of the body 4. The pattern in the non-coated portion 2 is thus more highlighted and looks more stereo.

It is noted that the pigment may be coated on the outer surface of the substrate before the coating material is coated on the outer surface of the substrate. A part of the pigment layer 20 covers on at least a partial area of the non-coated portion (the closed area can be considered as a part of the non-coated portion) and another part of the pigment layer 20 is covered by the coated layer 10. The part of the pigment layer 20 which covers on the at least a partial area of the non-coated portion and the another part of the pigment layer 20 which is covered by the coated layer 10 are continuous (as shown in FIG. 1B).

The present invention further provides a method, as shown in FIG. 1A, similar to the prior one, in which the method includes the following steps:

Material Preparation: preparing a coating material by mixing and blending a binder and a thermo-expandable powder consisting of a plurality of thermo-expandable microcapsules.

Pigment Coating: coating a pigment on at least a part of substrate to form a pigment layer;

Coating Material Coating: Coating the coating material on a part of an outer surface of the pigment-coated substrate to form a coated layer. At least one non-coated portion is formed on the substrate, and the non-coated portion is defined by the coated layer. At least a part of the pigment layer is located in the non-coated portion; and

Foaming: heating the coated substrate till the coated layer foams so that the coated layer becomes a foam layer. The non-coated portion is thus defined by the foam layer instead.

As shown in FIG. 1B, the coating material is coated on the substrate to form two coated layers 10 after the substrate is coated with a pigment layer 20. When the coated layers 10 are foamed to become the foam layers 30 as shown in FIG. 1C, the pigment layer 20 remains in a good shape. Preferably the foam layer is light transmissive (transparent or semi-transparent) so that the user can see the pattern overlapped by the foam layer. In other words, at least a part of the pigment layer is located in the non-coated portion and continuously extending to terminate between the coated layer and the outer surface of the substrate so that the at least a part of the pigment layer is partially overlapped by the coated layer.

What is claimed is:

1. A method of forming a pigment layer and a foam layer on a first side face of a substrate, a second side face of the substrate which is opposite to the first side face being entirely uncovered, the method consisting of the following steps in order:
preparing a coating material consisting of a binder and a thermo-expandable powder consisting of a plurality of thermo-expandable microcapsules by mixing and blending, each thermo-expandable microcapsule consisting of a thermoplastic polymer shell and a low-boiling-point solvent wrapped by the thermoplastic polymer shell, a low-boiling point of the low-boiling-point solvent being lower than a foaming point of the thermo-expandable microcapsules, the foaming point being within 80-200 degrees Celsius;
coating the coating material on a part of an outer surface of the substrate to form a coated layer, at least one non-coated portion being formed on the substrate, the non-coated portion being defined by the coated layer;
drying the coated layer at a temperature lower than the foaming point of the thermo-expandable microcapsules so that the coated layer adhere to the substrate and becomes a non-sticky coated layer;
coating a pigment continuously on at least a part of the non-coated portion and at least a part of the non-sticky coated layer to form a pigment layer; and
heating the coated substrate and the pigment layer till the coated layer foams so that the coated layer becomes a foam layer, the foam layer raises a part of the pigment layer thereon and thins a part of the pigment layer between the foam layer and the non-coated portion, the non-coated portion being thus defined by the foam layer instead;
wherein the pigment layer is layered continuously on the foam layer and the non-coated portion;
wherein the substrate is made from non-foamable material which is selected from paper or plastic;
wherein the pigment layer is entirely exposed to outside.

2. The method of claim 1, wherein the binder is selected from a group consisting of polyvinyl acetate resin, ethylene vinyl acetate resin, polyurethane resin and a mixture thereof.

3. The method of claim 2, wherein the binder is oleoresin which consists of an oil-based polyurethane resin accounting for 5% to 20% of a total weight of the coating material.

4. The method of claim 1, wherein the coated layer is heated with a heating device on the outer surface and an inner surface of the substrate simultaneously, and the coated layer is heated in a manner of directly touching the coated layer with the heating device and of disposing the heating device closely to the inner surface of the substrate so as to instantly heat the inner surface without touching it.

5. The method of claim 3, wherein the coated layer is heated with a heating device on the outer surface and an inner surface of the substrate simultaneously, and the coated layer is heated in a manner of directly touching the coated layer with the heating device and of disposing the heating device closely to the inner surface of the substrate so as to instantly heat the inner surface without touching it.
